(19) United States
(12) Patent Application Publication
(10) Pub. No.: US 2008/0079239 A1
(43) Pub. Date: Apr. 3, 2008

(54) FOLDABLE STROLLER

(75) Inventor: Weiqiong Li, Kunshan (CN)

Correspondence Address: RICHARD M. GOLDBERG, 25 EAST SALEM STREET, SUITE 419, HACKENSACK, NJ, 07601, US

(73) Assignee: DELTA ENTERPRISE CORP., New York, NY (US)

(21) Appl. No.: 11/751,203

(22) Filed: May 21, 2007

(30) Foreign Application Priority Data
Sep. 29, 2006 (CN) 200620076756.5

(51) Int. Cl. B62B 7/06

(52) U.S. Cl. 280/642

(57) ABSTRACT

A foldable stroller includes a frame, a front wheel component, and a rear wheel component; the frame includes side frames symmetrically positioned on the left and right; a multiple of cross bars are connected between the two side frames; the side frame comprises a front wheel support, a rear wheel support and a push-hold rod; the front wheel support is pin-jointed at the rear end with a sliding sleeve, which is sheathed around the rear wheel support, whose front end is rotatably connected with the front end of the push-hold rod through a rotating seat; a front support rod is pin-jointed between foreparts of the front wheel support and the rear wheel support; a rear support rod is pin-jointed between the push-hold rod and the sliding sleeve; when the frame is in an unfolding state, the sliding sleeve moves on the rear wheel support up to the highest position, and is locked by the locking mechanism on the rear wheel support; and the whole frame of the stroller is of a three-segment structure when folded, with a smaller volume after folding that is convenient to place and carry, which is more convenient to use, and improved in safety.

### FIELD OF THE INVENTION

The present utility model relates to a folding baby carriage.

### BACKGROUND OF THE INVENTION

The baby carriages currently available on the market generally comprise a frame with a lifting bag, a basket or a seat; the frame is provided with a front wheel component at the front bottom and a rear wheel component at the rear bottom; the frame comprises two symmetrically positioned side frames on the left and right, and a multiple of cross bars connected in between thereof; each side frame comprises a front wheel support, a rear wheel support and a push-hold rod; and the frame can be locked when the carriage is unfolded.

The disadvantages of such a carriage are as follows:

1. The whole frame when folded is basically of a two-segment structure, with a still large volume after folding that is inconvenient to place and carry.

2. The frame structure is relatively complicated, with more interference during folding, making it more troublesome to use.

### CONTENTS OF THE INVENTION

A purpose of the present utility model is to provide a folding baby carriage, whose whole frame is of a three-segment structure when folded, with a smaller volume after folding that is convenient to place and carry, which is more convenient to use, and improved in safety.

A technical solution of the present utility model is a folding baby carriage, comprising a frame, a front wheel component, and a rear wheel component; the frame comprises side frames symmetrically positioned on the left and right; a multiple of cross bars are connected between the two side frames; the side frame comprises a front wheel support, a rear wheel support and a push-hold rod; the front wheel support is pin-jointed at the rear end with a sliding sleeve, which is sheathed around the rear wheel support, whose front end is rotatably connected with the front end of the push-hold rod through a rotating seat; a front support rod is pin-jointed between foreparts of the front wheel support and the rear wheel support; a rear support rod is pin-jointed between the push-hold rod and the sliding sleeve; and when the frame is in an unfolding state, the sliding sleeve moves on the rear wheel support up to the highest position, and is locked by the locking mechanism on the rear wheel support.

A further technical solution of the present utility model is a folding baby carriage, comprising a frame, a front wheel component, and a rear wheel component; the frame comprises side frames symmetrically positioned on the left and right; a multiple of cross bars are connected between the two side frames; the side frame comprises a front wheel support, a rear wheel support and a push-hold rod; the front wheel support is pin-jointed at the rear end with a sliding sleeve, which is sheathed around the rear wheel support, whose front end is rotatably connected with the front end of the push-hold rod through a rotating seat; a front support rod is pin-jointed between foreparts of the front wheel support and the rear wheel support; a rear support rod is pin-jointed between the push-hold rod and the sliding sleeve; when the frame is in an unfolding state, the sliding sleeve moves on the rear wheel support up to the highest position, and is locked by the locking mechanism on the rear wheel support; the locking mechanism comprises a fixing seat fixed in the intercavity of the rear wheel support; the fixing seat is provided inside with a long groove hole, which is provided inside with a pin hook, whose lower end is fixed at the fixing seat with a pin; the pin hook is provided with a locking block in front of the upper end; the rear wheel support and the sliding sleeve corresponding to the locking block are provided with a locking hole; the pin hook is provided in rear of the upper end with a pressing spring, which presses the locking block into the locking hole; and the pin hook is also connected in rear of the upper end with a pulling rope, which is backward round a pin axis and then connected with a folding handle at the upper part of the push-hold rod via a through hole in the fixing seat.

A more detailed technical solution of the present utility model is a folding baby carriage, comprising a frame, a front wheel component, and a rear wheel component; the frame comprises side frames symmetrically positioned on the left and right; a multiple of cross bars are connected between the two side frames; the side frame comprises a front wheel support, a rear wheel support and a push-hold rod; the front wheel support is pin-jointed at the rear end with a sliding sleeve, which is sheathed around the rear wheel support, whose front end is rotatably connected with the front end of the push-hold rod through a rotating seat; a front support rod is pin-jointed between foreparts of the front wheel support and the rear wheel support; a rear support rod is pin-jointed between the push-hold rod and the sliding sleeve; when the frame is in an unfolding state, the sliding sleeve moves on the rear wheel support up to the highest position, and is locked by the locking mechanism on the rear wheel support; the locking mechanism comprises a fixing seat fixed in the intercavity of the rear wheel support; the fixing seat is provided inside with a long groove hole, which is provided inside with a pin hook, whose lower end is fixed at the fixing seat with a pin; the pin hook is provided with a locking block in front of the upper end; the rear wheel support and the sliding sleeve corresponding to the locking block are provided with a locking hole; the pin hook is provided in rear of the upper end with a pressing spring, which presses the locking block into the locking hole; the pin hook is also connected in rear of the upper end with a pulling rope, which is backward round a pin axis and then connected with a folding handle at the upper part of the push-hold rod via a through hole in the fixing seat; the folding handle is provided radially with a pulling pin, which is through an axial groove provided on the push-hold rod; the other end of the pulling rope connecting the pin hook is connected to the pulling pin through the intercavity of the rear wheel support, the intercavity of the rotating seat, and the intercavity of the push-hold rod; and the rear wheel support is provided with a limit sleeve fixed at the upper part of the sliding sleeve.

The advantages of the present utility model are as follows:

1. A four connecting rod mechanism is constituted on the side support of the present utility model by the push-hold rod, the front wheel support, the front support rod, and the rear support rod; the rear wheel support is located at the diagonal of this four connecting rod mechanism, and sheathed with the sliding sleeve; the front wheel support and the rear support rod are pin-jointed to the sliding sleeve, respectively; the sliding sleeve slides downward to make the frame folded, and slides upward to make the frame unfolded and locked; and the whole frame when folded is of a S-shaped three-segment structure, with a smaller volume after folding that is convenient to place and carry.

2. Compared with the prior art, the present utility model provides the folding and locking mechanism at the rear wheel support, and control by pulling the pulling rope through the folding handle, thus effectively removing potential safety hazards in the prior art and greatly improving usage safety of products; when the carriage is folded, the front wheel support will be folded close below the rear wheel support as the sliding sleeve moves, with a smaller volume, which is convenient to carry; and the whole carriage is rich in arc lines, which is not only attractive, but also safe and convenient to use.

3. The frame structure of the present utility model is simpler, with less interference during folding, which is more convenient to use and safer.

### BRIEF DESCRIPTION OF THE DRAWINGS

The present utility model will be further described below according to drawings and embodiments.

FIG. 1 is a schematic drawing of the present utility model in an unfolding state.

FIG. 2 is a side view of FIG. 1.

FIG. 3 is a schematic drawing of the present utility model in a semi-folding state.

FIG. 4 is a side view of FIG. 3.

FIG. 5 is a schematic drawing of the present utility model in a folding state.

FIG. 6 is a schematic drawing of the locking mechanism in a locking state.

FIG. 7 is a schematic drawing of the locking mechanism in an unlocking state.

FIG. 8 is a schematic drawing of the unlocking mechanism.

Where: 1 frame; 2 front wheel component; 3 rear wheel component; 4 side frame; 5 front wheel support; 6 rear wheel support; 7 push-hold rod; 8 sliding sleeve; 9 rotating seat; 10 front support rod; 11 rear support rod; 12 fixed seat; 13 long groove hole; 14 pin hook; 15 pin; 16 locking block; 17 locking hole; 18 pressing spring; 19 pin axis; 20 pulling rope; 21 folding handle; 22 pulling pin; 23 axial groove; 24 limit sleeve; 25 through hole.

### DETAILED DESCRIPTION OF THE EMBODIMENTS

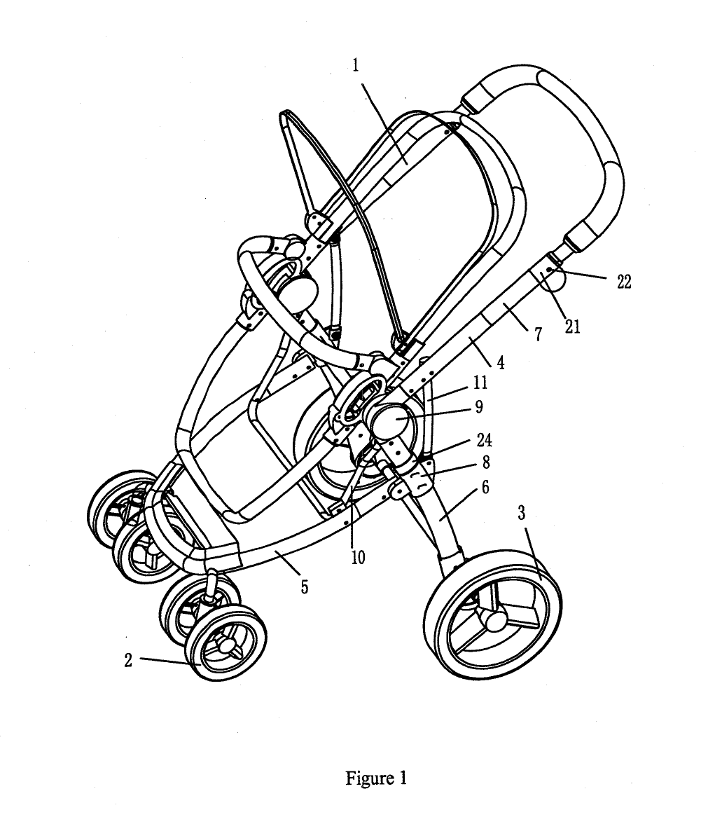

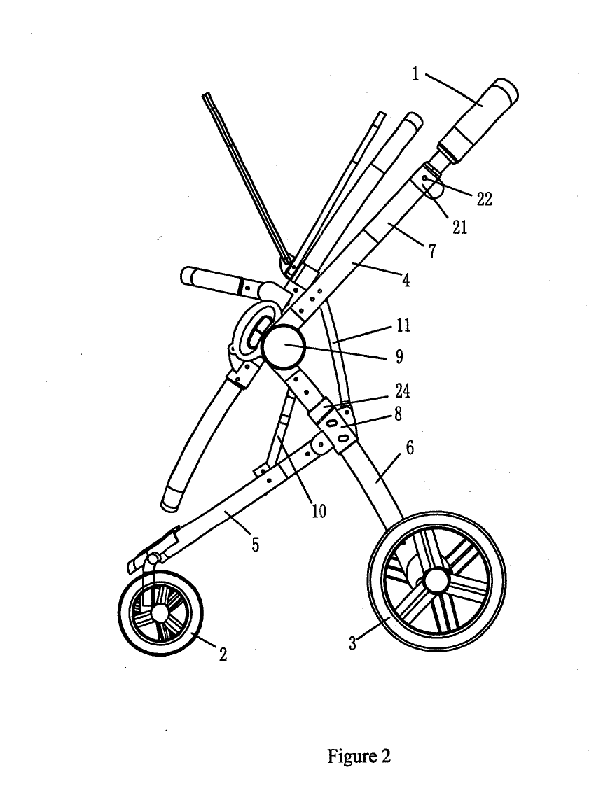

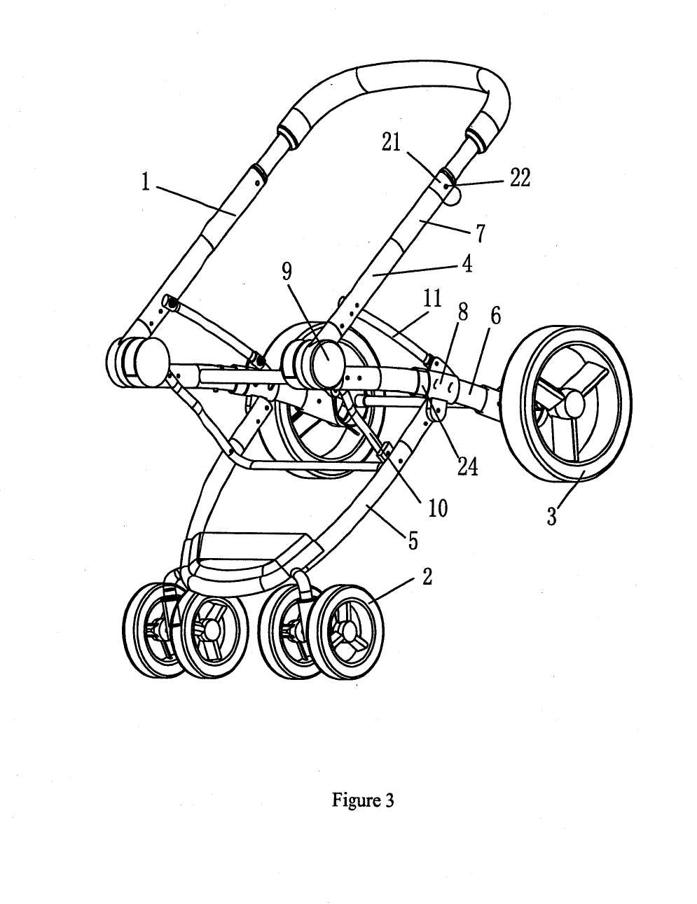

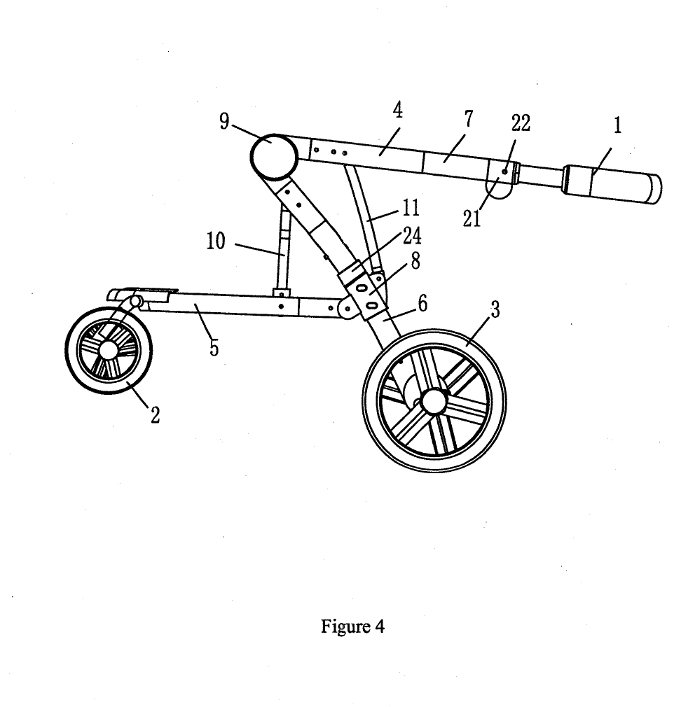

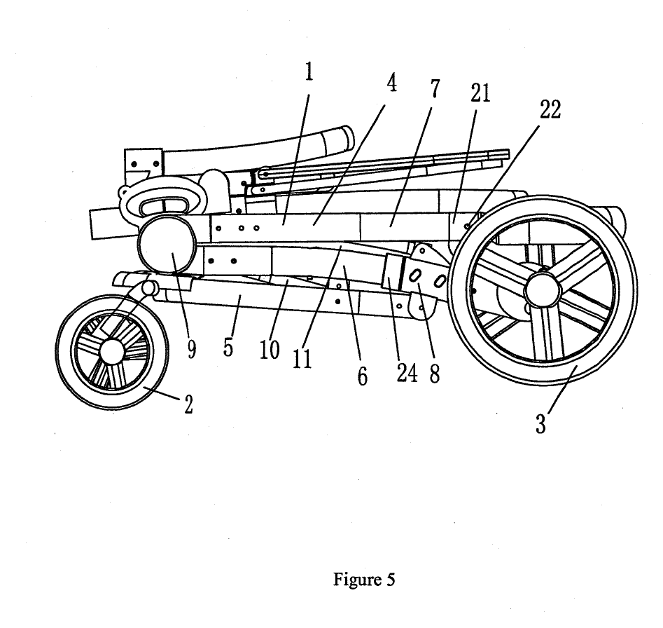

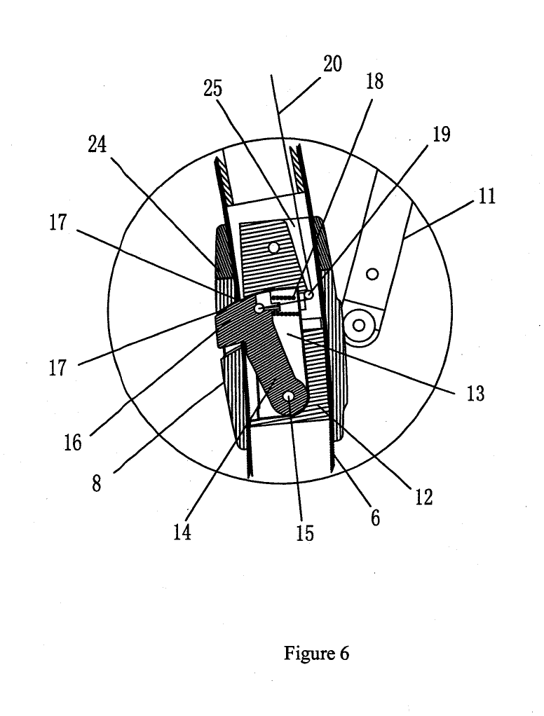

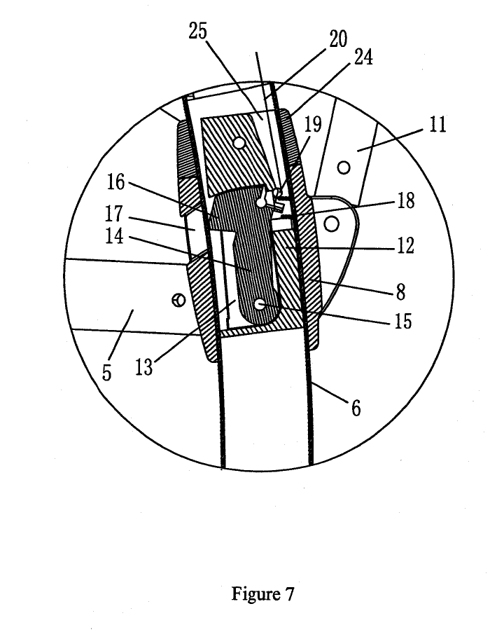

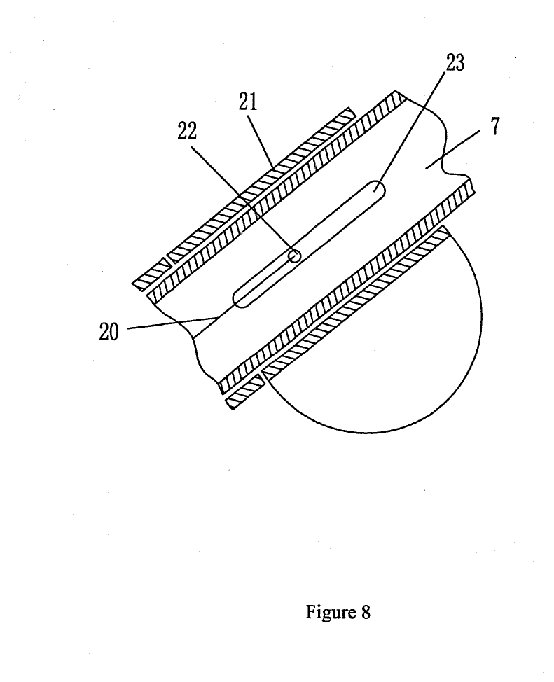

Embodiment: A folding baby carriage as shown in FIG. 1, FIG. 2, FIG. 3, FIG. 4, FIG. 5, FIG. 6, FIG. 7, and FIG. 8, comprising a frame 1, a front wheel component 2, and a rear wheel component 3; the frame 1 comprises side frames 4 symmetrically positioned on the left and right; a multiple of cross bars are connected between the two side frames 4; the side frame 4 comprises a front wheel support 5, a rear wheel support 6 and a push-hold rod 7; the front wheel support 5 is pin-jointed at the rear end with a sliding sleeve 8, which is sheathed around the rear wheel support 6, whose front end is rotatably connected with the front end of the push-hold rod 7 through a rotating seat 9; a front support rod 10 is pin-jointed between foreparts of the front wheel support 5 and the rear wheel support 6; a rear support rod 11 is pin-jointed between the push-hold rod 7 and the sliding sleeve 8; when the frame 1 is in an unfolding state, the sliding sleeve 8 moves on the rear wheel support 6 up to the highest position, and is locked by the locking mechanism on the rear wheel support 6; and when the sliding sleeve 8 is in a locking position, the rear wheel support 6 is provided with a limit sleeve 24 fixed at the upper part of the sliding sleeve 8.

The locking mechanism comprises a fixing seat 12 fixed in the intercavity of the rear wheel support 6; the fixing seat 12 is provided inside with a long groove hole 13, which is provided inside with a pin hook 14, whose lower end is fixed at the fixing seat 12 with a pin 15; the pin hook 14 is provided with a locking block 16 in front of the upper end; the rear wheel support 6 and the sliding sleeve 8 corresponding to the locking block 16 are provided with a locking hole 17; the pin hook 14 is provided in rear of the upper end with a pressing spring 18, which presses the locking block 16 into the locking hole 17; the pin hook 14 is also connected in rear of the upper end with a pulling rope 20, which is backward round a pin axis 19 and then connected with a folding handle 21 at the upper part of the push-hold rod 7 via a through hole 25 in the fixing seat 12; the folding handle 21 is provided radially with a pulling pin 22, which is through an axial groove 23 provided on the push-hold rod 7; and the other end of the pulling rope 20 connecting the pin hook 14 is connected to the pulling pin 22 through the intercavity of the rear wheel support 6, the intercavity of the rotating seat 9, and the intercavity of the push-hold rod 7.

To fold a carriage, lift the folding handle 21 upward, the pulling rope 20 will drive the pin hook 14 to turn, which will retract into the rear wheel support 6 and meanwhile apply a downward force to the push-hold rod 7, and the carriage can then be folded;

To unfold the carriage to use, lift up the push-hold rod 7 with two hands, the sliding sleeve 5 will slide upward to the position of the limit sleeve 24, the pin hook 14 win be embedded under elasticity of the pressing spring 18 into the locking hole 17 in the rear wheel support 6 and the sliding sleeve 8, the sliding sleeve 8 will be locked, and thus the carriage is in an unfolding state for usage.

What is claimed is:

1. A foldable stroller, comprising a frame (1), a front wheel component (2), and a rear wheel component (3); the frame (1) comprises side frames (4) symmetrically positioned on the left and right; a multiple of cross bars are connected between the two side frames (4) wherein the side frames (4) comprise a front wheel support (5), a rear wheel support (6) and a push-hold rod (7); the front wheel support (5) is pin-jointed at the rear end with a sliding sleeve (8), which is sheathed around the rear wheel support (6), whose front end is rotatably connected with the front end of the push-hold rod (7) through a rotating seat (9); a front support rod (10) is pin-jointed between foreparts of the front wheel support (5) and the rear wheel support (6); a rear support rod (11) is pin-jointed between the push-hold rod (7) and the sliding sleeve (8); and when the frame (1) is in an unfolding state, the sliding sleeve (8) moves on the rear wheel support (6) up to the highest position, and is locked by the locking mechanism on the rear wheel support (6).

2. The foldable stroller according to claim 1, wherein the locking mechanism comprises a fixing seat (12) fixed in the intercavity of the rear wheel support (6); the fixing seat (12) is provided inside with a long groove hole (13), which is provided inside with a pin hook (14), whose lower end is fixed at the fixing seat (12) with a pin (15); the pin hook (14) is provided with a locking block (16) in front of the upper end; the rear wheel support (6) and the sliding sleeve (8) corresponding to the locking block (16) are provided with a locking hole (17); the pin hook (14) is provided in rear of the upper end with a pressing spring (18), which presses the locking block (16) into the locking hole (17); and the pin hook (14) is also connected in rear of the upper end with a pulling rope (20), which is backward round a pin axis (19) and then connected with a folding handle (21) at the upper part of the push-hold rod (7) via a through hole (25) in the fixing seat (12).

3. The foldable stroller, according to claim 2, wherein the folding handle (21) is provided radially with a pulling pin (22), which is through an axial groove (23) provided on the push-hold rod (7); and the other end of the pulling rope (20) connecting the pin hook (14) is connected to the pulling pin (22) through the intercavity of the rear wheel support (6), the intercavity of the rotating seat (9), and the intercavity of the push-hold rod (7).

4. The foldable stroller according to claim 2, wherein when the sliding sleeve (8) is located at a locking position, the rear wheel support (6) is provided with a limit sleeve (24) fixed at the upper part of the sliding sleeve (8).
